(19) United States
(12) Patent Application Publication
(10) Pub. No.: US 2010/0245194 A1
(43) Pub. Date: Sep. 30, 2010

(54) LOOP ANTENNA UNIT

(75) Inventors: Tomohiro Sawazaki, Aichi (JP); Takuya Nagai, Aichi (JP)

Correspondence Address: DAY PITNEY LLP, 7 TIMES SQUARE, NEW YORK, NY, 10036-7311, US

(73) Assignee: Brother Kogyo Kabushiki Kaisha, Aichi-ken (JP)

(21) Appl. No.: 12/722,103

(22) Filed: Mar. 11, 2010

(30) Foreign Application Priority Data
Mar. 27, 2009 (JP) 2009-079995

(51) Int. Cl. H01Q 11/12

(52) U.S. Cl. 343/743

(57) ABSTRACT

A loop antenna unit includes a looped antenna element; a first feeding cable that feeds power to a first feeding point on the antenna element; a second feeding cable that feeds power to a second feeding point on the antenna element; and a circuit switching portion that disconnects a feeding cable corresponding to an unused feeding point out of the first feeding point and the second feeding point, from the unused feeding point, wherein the feeding cable transmits a signal generated by superposing a high-frequency signal related to communication by the loop antenna unit on a dc signal for control over switching by the circuit switching portion, and wherein the loop antenna unit further includes: a first filter that extracts a high-frequency signal related to communication by the loop antenna unit from a signal supplied through the feeding cable and supplies the extracted high-frequency signal to the antenna element; and a second filter that extracts a dc signal for control over switching by the circuit switching portion from a signal supplied through the feeding cable and supplies the extracted dc signal to the circuit switching portion, the first filter and the second filter being provided for the first feeding cable and for the second feeding cable, respectively.

### CROSS REFERENCE TO RELATED APPLICATION

The present application claims priority from Japanese Patent Application No. 2009-079995, which was filed on Mar. 27, 2009, the disclosure of which is incorporated herein by reference in its entirety.

### BACKGROUND OF THE INVENTION

1. Field of the Invention

The present invention relates generally to a loop antenna unit having a looped antenna element, and, more particularly, to an improvement in a loop antenna unit that enables suitable polarization plane switching in a simple configuration.

2. Description of the Related Art

A radio frequency identification (hereinafter “RFID”) system has been known, which causes a prescribed radio tag communication apparatus (inquirer) to read information contactlessly out of a small radio tag (responder) having given information stored therein. According to this RFID system, even if the radio tag is soiled or is located in a concealed place, information stored in the radio tag can be read out through communication between the radio tag and the radio tag communication apparatus. The RFID system, therefore, is expected to be put in practical applications in various fields of commodity management, inspection process, etc.

Usually, the radio tag communication apparatus communicates with the radio tag by transmitting a given transmission signal (carrier wave) to the radio tag through a transmitting antenna and receiving a reply signal (reflected wave) transmitted back from the radio tag having received the transmission signal through a receiving antenna (which may be combined with the transmission antenna). When the relative position relation between the radio tag communication apparatus and the radio tag is not proper, however, communication sensitivity substantially deteriorates to pose a problem. Specifically, when a polarization plane (plane on which electric field components oscillate) of the antenna incorporated in the radio tag communication apparatus is perpendicular to a polarization plane of a reflected wave from the radio tag, the antenna is hardly able to receive the reflected wave. To solve such a problem, adopting an antenna capable of switching a polarization plane may be considered. For example, such an antenna is provided as a polarization switching loop antenna.

A loop antenna capable of polarization plane switching, that is, a loop antenna unit having a looped antenna element with two feeding points corresponding respectively to first and second polarization planes selectively feeds power to the two feeding points to switch a polarization plane. In this case, the influence of a feeding cable connected to an unselected feeding point, i.e., unused feeding point is not negligible. To deal with this, the feeding cable corresponding to the unused feeding point may be disconnected by a switch. According to the conventional technique, however, a control line for control over switching by such a switch is required. Switching control of an ordinary high-frequency switch is carries out in such a way that a high-frequency dc signal and a low-frequency dc signal are applied to two control lines, respectively, and are reversed to control switching by the high-frequency switch. This requires at least two control lines, thus leads to a complicated configuration. For this reason, development of a loop antenna unit capable of suitable polarization plane switching in a simple configuration has been in demand.

### SUMMARY OF THE INVENTION

The present invention was conceived in view of the circumstances, and it is therefore an object of the present invention to provide a loop antenna unit capable of suitable polarization plane switching in a simple configuration.

The object indicated above is achieved in the first mode of the present invention, which provides a loop antenna unit including: a looped antenna element; a first feeding cable that feeds power to a first feeding point on the antenna element; a second feeding cable that feeds power to a second feeding point on the antenna element; and a circuit switching portion that disconnects a feeding cable corresponding to an unused feeding point out of the first feeding point and the second feeding point, from the unused feeding point, wherein the feeding cable transmits a signal generated by superposing a high-frequency signal related to communication by the loop antenna unit on a dc signal for control over switching by the circuit switching portion, and wherein the loop antenna unit further includes: a first filter that extracts a high-frequency signal related to communication by the loop antenna unit from a signal supplied through the feeding cable and supplies the extracted high-frequency signal to the antenna element; and a second filter that extracts a dc signal for control over switching by the circuit switching portion from a signal supplied through the feeding cable and supplies the extracted dc signal to the circuit switching portion, the first filter and the second filter being provided for the first feeding cable and for the second feeding cable, respectively.

Accordingly, the first and second feeding cables transmit signals generated by superposing a high-frequency signal related to communication by the loop antenna unit on the dc signals for controlling switching by the circuit switching portion. In addition, the loop antenna unit is provided with the first filters that extract high-frequency signals related to communication by the loop antenna unit from signals supplied through the first and second feeding cables to supply the extracted high-frequency signals to the antenna element and with the second filters that extract the dc signals for controlling switching by the circuit switching portion from signals supplied through the first and second feeding cables to supply the extracted dc signals to the circuit switching portion, the first and second filters corresponding to the first feeding cable and the second feeding cable, respectively. This enables control over polarization plane switching by a single element, and eliminates a need of providing a control line for such switching control. Hence the loop antenna unit capable of suitable polarization plane switching in a simple configuration is provided.

The object indicated above is achieved in the second mode of the present invention, which provides the loop antenna unit, wherein the loop antenna unit is incorporated in a communication apparatus that carries out control over polarization plane switching of switching a polarization plane of the loop antenna unit, and wherein a dc signal for control over switching by the circuit switching portion is used also as a switching signal for switching connection for the high-frequency signal in control over polarization plane switching by the communication apparatus. As a result, control over polarization plane switching can be achieved through simpler control in the loop antenna unit which is incorporated in the prescribed communication apparatus and whose polarization plane is switched by the communication apparatus.

The object indicated above is achieved in the third mode of the present invention, which provides the loop antenna unit, wherein each of the first feeding cable and the second feeding cable is a coaxial cable having an inner conductor and an outer conductor that are arranged coaxially. This allows the loop antenna unit having the practical feeding cables to achieve suitable polarization plane switching in a simple configuration.

The object indicated above is achieved in the fourth mode of the present invention, which provides the loop antenna unit, wherein the circuit switching portion disconnects both inner conductor and outer conductor of a coaxial cable corresponding to an unused feeding point out of the first feeding point and the second feeding point, from the unused feeding point in response to the dc signal. This achieves suitable polarization plane switching in a practical form.

The object indicated above is achieved in the fifth mode of the present invention, which provides the loop antenna unit, wherein the circuit switching portion disconnects an inner conductor of a coaxial cable corresponding to an unused feeding point out of the first feeding point and the second feeding point, from the unused feeding point in response to the dc signal. This achieves suitable polarization plane switching in a simpler configuration.

The object indicated above is achieved in the sixth mode of the present invention, which provides the loop antenna unit, wherein when the antenna element has a discontinuous portion, the circuit switching portion disconnects an inner conductor of the coaxial cable corresponding to an unused feeding point out of the first feeding point and the second feeding point, from the unused feeding point in response to the dc signal while bringing the discontinuous portion of the antenna element corresponding to the unused feeding point into connection. This achieves suitable polarization plane switching in a simple configuration, and further improves communication by the antenna element.

The object indicated above is achieved in the seventh mode of the present invention, which provides the loop antenna unit, wherein when the antenna element has a discontinuous portion, the circuit switching portion disconnects both inner conductor and outer conductor of the coaxial cable corresponding to an unused feeding point out of the first feeding point and the second feeding point, from the unused feeding point in response to the dc signal while bringing the discontinuous portion of the antenna element corresponding to the unused feeding point into connection. This achieves suitable polarization plane switching in a practical form, and further improves communication by the antenna element.

The object indicated above is achieved in the eighth mode of the present invention, which provides the loop antenna unit, including: a third filter that supplies a dc signal for control over switching by the circuit switching portion to the antenna element while cutting off inflow of a high-frequency signal related to communication by the antenna element into the circuit switching portion; a fourth filter that extracts a dc signal for control over switching by the circuit switching portion from a signal supplied via the antenna element and supplies the extracted dc signal to the circuit switching portion; and a fifth filter that cuts off inflow of the dc signal supplied to the antenna element into the feeding cable. According to the loop antenna units, in a configuration having two or more circuit switching portions, a control line is not needed to be provided between the circuit switching portions, so that the configuration of the loop antenna unit can be simplified substantially.

### BRIEF DESCRIPTION OF THE DRAWINGS

FIG. 1 is an explanatory diagram of a radio tag communication system to which the present invention applies preferably;

FIG. 2 is an explanatory diagram of a configuration of a radio tag circuit element incorporated in a radio tag in the radio tag communication system of FIG. 1;

FIG. 3 depicts a configuration of a radio tag communication apparatus to which a loop antenna unit as an embodiment of the present invention applies;

FIG. 4 depicts a truth table for switching control of first to fourth switches in the loop antenna unit of FIG. 3;

FIG. 5 is an explanatory diagram of control over polarization plane switching responding to a dc signal in the loop antenna unit of FIG. 3;

FIG. 6 depicts a configuration of a loop antenna unit as an another embodiment of the present invention that applies to the radio tag communication apparatus;

FIG. 7 is an explanatory diagram of control over polarization plane switching responding to a dc signal in the loop antenna unit of FIG. 6;

FIG. 8 depicts a configuration of a loop antenna unit as still another embodiment of the present invention that applies to the radio tag communication apparatus;

FIG. 9 depicts a configuration of a loop antenna unit as still another embodiment of the present invention that applies to the radio tag communication apparatus;

FIG. 10 depicts a modification of the loop antenna unit of FIG. 3 that has a configuration in which a dc signal is superposed in an antenna element to dispense with a control line between feeding points;

FIG. 11 depicts a modification of the loop antenna unit of FIG. 6 that has a configuration in which a dc signal is superposed in an antenna element to dispense with a control line between feeding points;

FIG. 12 depicts a modification of the loop antenna unit of FIG. 8 that has a configuration in which a dc signal is superposed in an antenna element to dispense with a control line between feeding points; and

FIG. 13 depicts a modification of the loop antenna unit of FIG. 9 that has a configuration in which a dc signal is superposed in an antenna element to dispense with a control line between feeding points.

### DETAILED DESCRIPTION OF THE PREFERRED EMBODIMENTS

Preferred embodiments of the present invention will now be described in detail with reference to the accompanying drawings.

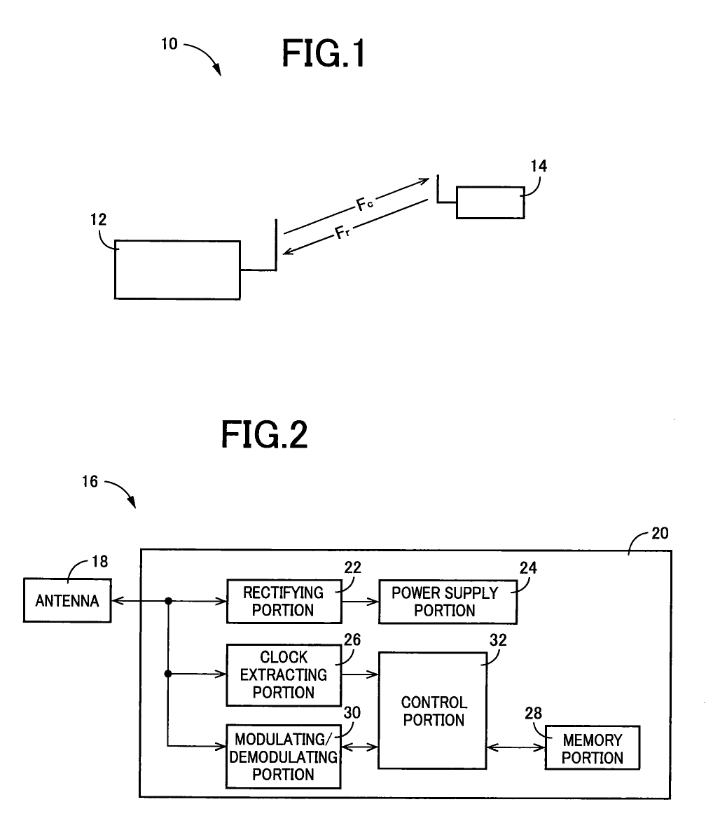

In FIG. 1, a radio tag communication system 10 includes a radio tag communication apparatus 12 having a loop antenna unit 36 provided as an embodiment of the present invention, and a single or a plurality (single in FIG. 1) of radio tags 14 with which the radio tag communication apparatus 12 communicates. The radio tag communication system 10 operates as so-called RFID system in which the radio tag communication apparatus 12 functions as an inquirer and the radio tag 14 functions as a responder. When the radio tag communication apparatus 12 transmits an inquiry wave Fc (transmission signal) to the radio tag 14, the radio tag 14 receiving the inquiry wave Fc modulates the inquiry wave Fc with a given information signal (data) and transmits the modulated inquiry wave Fc as a response wave Fr (reply signal) back to the radio tag communication apparatus 12. In this manner, communication between the radio tag communication apparatus 12 and the radio tag 14 is carried out for information exchange. The radio tag communication system 10, for example, is used for article management, etc., in a prescribed communication area, and the radio tag 14 is, preferably, pasted on an article to be managed, thus attached integrally to the article.

As depicted in FIG. 2, a radio tag circuit element 16 includes an antenna portion 18 that transmits/receives a signal to/from the radio tag communication apparatus 12 and an IC circuit portion 20 that is connected to the antenna portion 18 to carry out information communication with the radio tag communication apparatus 12. The IC circuit portion 20 functionally includes a rectifying portion 22 that rectifies the inquiry wave Fc from the radio tag communication apparatus 12 that is received by the antenna portion 18, a power supply portion 24 that accumulates the energy of the inquiry wave Fc rectified by the rectifying portion 22, a clock extracting portion 26 that extracts a clock signal from a carrier wave received by the antenna portion 18 to supply the clock signal to a control portion 32, a memory portion 28 functioning as an information storage portion capable of storing a given information signal, a modulating/demodulating portion 30 that is connected to the antenna portion 18 to modulate/demodulate a signal, and the control portion 32 that control operation of the radio tag circuit element 16 via the rectifying portion 22, the clock extracting portion 26, the modulating/demodulating portion 30, etc. The control portion 32 executes basic control, such as control for communicating with the radio tag communication apparatus 12 to store the given information in the memory portion 28 and control for causing the modulating/demodulating portion 30 to modulate the inquiry wave Fc received by the antenna portion 18 with the information signal stored in the memory portion 28 and transmitting back the modulated inquiry wave Fc as the response wave Fr through the antenna portion 18.

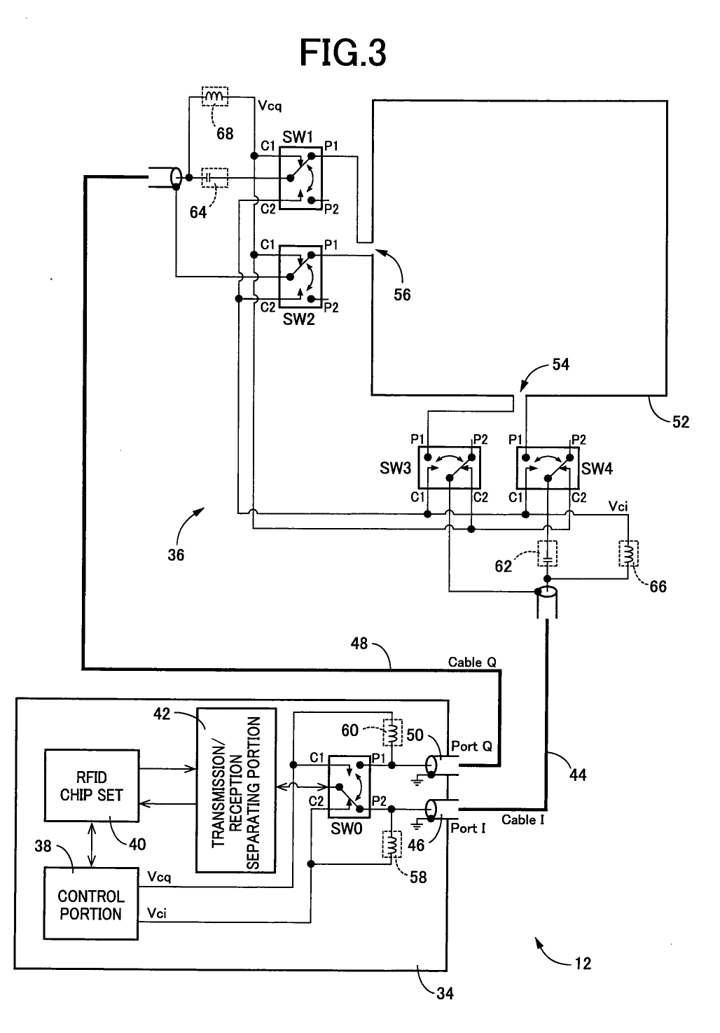

The radio tag communication apparatus 12 communicates with the radio tag 14 for information exchange to carry out at least information writing or information reading to or from the radio tag 14. As depicted in FIG. 3, the radio tag communication apparatus 12 includes a body 34 that carries out processes of outputting a transmission signal (high-frequency signal) related to the communication, demodulating a reply signal that is transmitted back from the radio tag 14 in response to the transmission signal, etc., and the loop antenna unit 36 as an embodiment of the present invention that is connected to the body 34 to function as a transmitting/receiving antenna related to the communication.

The body 34 has a control portion 38 that carries out various control, such as control of communication between the radio tag communication apparatus 12 and the radio tag 14, an RFID chip set 40 that carries out signal processing, such as outputting the transmission signal in response to a command from the control portion 38 and demodulating a reply signal from the radio tag 14, a transmission/reception separating portion 42 that supplies a transmission signal output from the RFID chip set 40 to a first port 46 or a second port 50 via a 0th switch SW0 and supplies a reception signal coming in from the first port 46 or the second port 50 via the 0th switch SW0 to the RFID chip set 40, the first port (Port I) 46 that is the input/output port corresponding to a first feeding cable 44, the second port (Port Q) 50 that is the input port corresponding to a second feeding cable 48, and the 0th switch SW0 that switches connection between the transmission/reception separating portion 42 and the first port 46 and the second port 50. The transmission/reception separating portion 42 is provided preferably as a widely known directional coupler, circulator, etc.

The control portion 38 is a so-called microcomputer that is composed of a CPU (Central Processing Unit), a ROM (Read-Only Memory), a RAM (Random Access Memory), etc., and that carries out signal processing in accordance with a program stored in advance in the ROM while using the temporary storage function of the RAM. The control portion 38 transmits a given transmission signal to the radio tag 14 via the RFID chip set 40 and demodulates or decodes a reply signal transmitted back from the radio tag 14 in response to the transmission signal in carrying out control over communication between the radio tag communication apparatus 12 and the radio tag 14. The control portion 38 outputs dc signals Vci and Vcq for switching by the 0th switch SW0. These dc signals Vci and Vcq are used also for switching by first to fourth switches SW1 to SW4 serving as a circuit switching portion incorporated in the loop antenna unit 36, which will be described later.

The loop antenna unit 36 has a rectangular (square) antenna element 52 that is of a looped shape having a first feeding point 54 corresponding to a first polarization plane (horizontal polarization plane) and a second feeding point 56 corresponding to a second polarization plane (vertical polarization plane), both feeding points being shifted to each other by ¼ wavelength (¼ of a wavelength related to communication), and that has a length dimension equivalent to one wavelength related to communication, the first feeding cable 44 for feeding power to the first feeding point 54 of the antenna element 52, the second feeding cable 48 for feeding power to the second feeding point 56 of the antenna element 52, and the first to fourth switches SW1 to SW4 serving as the circuit switching portion that disconnect the first feeding cable 44 or the second feeding cable 48 corresponding to an unused feeding point out of the first feeding point 54 and the second feeding point 56, from the unused feeding point. One of the first feeding cable 44 and the second feeding cable 48 is connected to one of the first feeding point 54 and the second feeding point 56 of the antenna element 52. This causes the antenna element 52 to function as a single wavelength loop antenna. The loop antenna unit 36 is, therefore, a polarization plane switching antenna unit (polarization plane diversity antenna) caused to function selectively as a horizontal polarization antenna or a vertical polarization antenna.

Preferably, each of the first feeding cable 44 and the second feeding cable 48 be a coaxial cable having an inner conductor and an outer conductor that are arranged coaxially. The first feeding cable 44 connects the first port 46 of the body 34 to the first feeding point 54 of the antenna element 52, serving as a horizontal polarization cable (cable I) for allowing the loop antenna unit 36 to function as a horizontal polarization antenna. The second feeding cable 48 connects the second port 50 of the body 34 to the second feeding point 56 of the antenna element 52, serving as a vertical polarization cable (cable Q) for allowing the loop antenna unit 36 to function as a vertical polarization antenna.

The first switch SW1 switches connection and disconnection between the inner conductor of the second feeding cable 48 and the second feeding point 56 of the antenna element 52. When connected to a terminal P1, the first switch SW1 connects the inner conductor of the second feeding cable 48 to the second feeding point 56 of the antenna element 52. When connected to a terminal P2, the first switch SW1 disconnects the inner conductor of the second feeding cable 48 from the second feeding point 56 of the antenna element 52. The second switch SW2 switches connection and disconnection between the outer conductor of the second feeding cable 48 and the second feeding point 56 of the antenna element 52. When connected to a terminal P1, the second switch SW2 connects the outer conductor of the second feeding cable 48 to the second feeding point 56 of the antenna element 52. When connected to a terminal P2, the second switch SW2 disconnects the outer conductor of the second feeding cable 48 from the second feeding point 56 of the antenna element 52. The third switch SW3 switches connection and disconnection between the outer conductor of the first feeding cable 44 and the first feeding point 54 of the antenna element 52. When connected to a terminal P1, the third switch SW3 connects the outer conductor of the first feeding cable 44 to the first feeding point 54 of the antenna element 52. When connected to a terminal P2, the third switch SW3 disconnects the outer conductor of the first feeding cable 44 from the first feeding point 54 of the antenna element 52. The fourth switch SW4 switches connection and disconnection between the inner conductor of the first feeding cable 44 and the first feeding point 54 of the antenna element 52. When connected to a terminal P1, the fourth switch SW4 connects the inner conductor of the first feeding cable 44 to the first feeding point 54 of the antenna element 52. When connected to a terminal P2, the fourth switch SW4 disconnects the inner conductor of the first feeding cable 44 from the first feeding point 54 of the antenna element 52.

In the body 34, the 0th switch SW0 switches connection between the transmission/reception separating portion 42 and the first port 46 and the second port 50. When connected to a terminal P1, the 0th switch SW0 connects the transmission/reception separating portion 42 to the second port 50. When connected to a terminal P2, the 0th switch SW0 connects the transmission/reception separating portion 42 to the first port 46. Through such circuit switching, a high-frequency signal output from the RFID chip set 40 to pass through the transmission/reception separating portion 42 is supplied selectively to one of the first feeding cable 44 and the second feeding cable 48 via the 0th switch SW0, while a reception signal coming in from one of the first feeding cable 44 and the second feeding cable 48 is supplied to the transmission/reception separating portion 42 and further to the RFID chip set 40 via the 0th switch SW0. Switching by the 0th switch SW0 is carried out in response to the dc signals (switching signals) Vci and Vcq. When the dc signal Vci corresponding to horizontal polarization out of the dc signals Vci and Vcq is higher in voltage than the dc signal Vcq corresponding to vertical polarization, the 0th switch SW0 is connected to the terminal P2, which consequently connects the transmission/reception separating portion 42 to the first port 46. When the dc signal Vcq corresponding to vertical polarization is higher in voltage than the dc signal Vci corresponding to horizontal polarization, the 0th switch SW0 is connected to the terminal P1, which consequently connects the transmission/reception separating portion 42 to the second port 50.

In the loop antenna unit 36 of this embodiment, the dc signals Vci and Vcq for switching connection between the transmission/reception separating portion 42 and the first port 46 and the second port 50 in the radio tag communication apparatus 12 are used also for controlling switching by the first to fourth switches SW1 to SW4. The first and second feeding cables 44 and 48 thus transmit signals generated by superposing a high-frequency signal related to communication by the loop antenna unit 36, i.e., a signal output from the RFID chip set 40 to pass through the transmission/reception separating portion 42 on the dc signals Vci and Vcq output from the control portion 38 to pass through low-pass filters (hereinafter “LPF”) 58 and 60 to be input to the first and second ports 46 and 50. The loop antenna unit 36 is provided with high-pass filters (hereinafter “HPF”) 62 and 64 serving as first filters that extract high-frequency signals related to communication by the loop antenna unit 36 from signals supplied through the first and second feeding cables 44 and 48 to supply the extracted signals to the antenna element 52 and with LPFs 66 and 68 serving as second filters that extract the dc signals Vci and Vcq for controlling switching by the first to fourth switches SW1 to SW4 from signals supplied through the first and second feeding cables 44 and 48 to supply the extracted signals to the first to fourth switches SW1 to SW4, the HPF 62 and LPF 66 and HPF 64 and LPF 68 corresponding to the first feeding cable 44 and the second feeding cable 48, respectively. The HPFs 62 and 64 may be provided by using coupling capacitors necessary for switching device operation also as the HPFs 62 and 64, in which case separate HPFs are unnecessary.

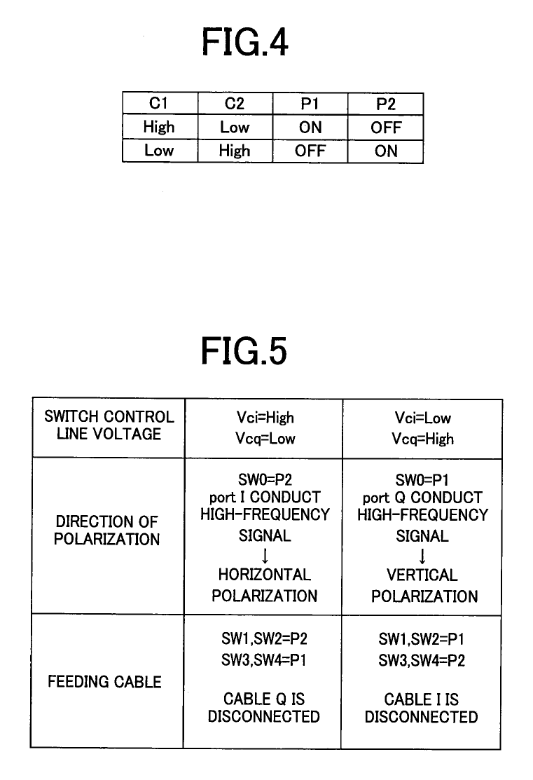

In the loop antenna unit 36 configured in the manner, the first to fourth switches SW1 to SW4 switch on and off in response to the dc signals Vci and Vcq supplied from the control portion 38 to the switches SW1 to SW4 via the feeding cables 44 and 48. As depicted in FIGS. 4 and 5, when the dc signal Vci corresponding to horizontal polarization out of the dc signals Vci and Vcq is higher in voltage than the dc signal Vcq corresponding to vertical polarization, the first switch SW1 and the second switch SW2 are connected to the terminals P2 while the third switch SW3 and the fourth switch SW4 are connected to the terminals P1. In this state, as described above, the 0th switch SW0 in the body 34 is connected to the terminal P2 to connect the transmission/reception separating portion 42 to the first port 46, which causes a high-frequency signal output from the transmission/reception separating portion 42 to be supplied to the first feeding cable 44. In this state, the inner conductor and the outer conductor of the first feeding cable 44 are connected to the first feeding point 54, which is thus electrically connected to the transmission/reception separating portion 42. As a result, the antenna element 52 functions as a horizontal polarization antenna. Meanwhile, both inner conductor and outer conductor of the second feeding cable 48 corresponding to the unused second feeding point 56 are disconnected from the second feeding point 56.

As depicted in FIGS. 4 and 5, when the dc signal Vcq corresponding to vertical polarization out of the dc signals Vci and Vcq is higher in voltage than the dc signal Vci corresponding to horizontal polarization, the first switch SW1 and the second switch SW2 are connected to the terminals P1 while the third switch SW3 and the fourth switch SW4 are connected to the terminals P2. In this state, as described above, the 0th switch SW0 in the body 34 is connected to the terminal P1 to connect the transmission/reception separating portion 42 to the second port 50, which causes a high-frequency signal output from the transmission/reception separating portion 42 to be supplied to the second feeding cable 48. In this state, the inner conductor and the outer conductor of the second feeding cable 48 are connected to the second feeding point 56, which is thus electrically connected to the transmission/reception separating portion 42. As a result, the antenna element 52 functions as a vertical polarization antenna. Meanwhile, both inner conductor and outer conductor of the first feeding cable 44 corresponding to the unused first feeding point 54 are disconnected from the first feeding point 54.

According to this embodiment, the first and second feeding cables 44 and 48 transmit signals generated by superposing a high-frequency signal related to communication by the loop antenna unit 36 on the dc signals Vci and Vcq for controlling switching by the first to fourth switches SW1 to SW4 serving as the circuit switching portion. In addition, the loop antenna unit 36 is provided with the HPF 62 and 64 serving as the first filters that extract high-frequency signals related to communication by the loop antenna unit 36 from signals supplied through the first and second feeding cables 44 and 48 to supply the extracted high-frequency signals to the antenna element 52 and with the LPFs 66 and 68 serving as the second filters that extract the dc signals Vci and Vcq for controlling switching by the first to fourth switches SW1 to SW4 from signals supplied through the first and second feeding cables 44 and 48 to supply the extracted dc signals to the first to fourth switches SW1 to SW4, the HPF 62 and LPF 66 and HPF 64 and LPF 68 corresponding to the first feeding cable 44 and the second feeding cable 48, respectively. This enables control over polarization plane switching by a single element, and eliminates a need of providing a control line for such switching control. Hence the loop antenna unit 36 capable of suitable polarization plane switching in a simple configuration is provided.

The loop antenna unit 36 is incorporated in the radio tag communication apparatus 12 that carries out control over polarization plane switching of switching a polarization plane of the loop antenna unit 36. The dc signals Vci and Vcq for controlling switching by the first to fourth switches SW1 to SW4 are used also as signals for switching connection for the high-frequency signal in control over polarization plane switching by the radio tag communication apparatus 12. As a result, control over polarization plane switching can be achieved through simpler control in the loop antenna unit 36 which is incorporated in the prescribed radio tag communication apparatus 12 and whose polarization plane is switched by the radio tag communication apparatus 12.

Each of the first feeding cable 44 and the second feeding cable 48 is a coaxial cable having an inner conductor and an outer conductor that are arranged coaxially. This allows the loop antenna unit 36 having the practical feeding cables 44 and 48 to achieve suitable polarization plane switching in a simple configuration.

The first to fourth switches SW1 to SW4 disconnect both inner conductor and outer conductor of a coaxial cable corresponding to an unused feeding point out of the first and second feeding points 54 and 56, from the unused feeding point in response to the dc signals Vci and Vcq. This achieves suitable polarization plane switching in a practical form.

Another preferred embodiment of the present invention will then be described in detail with the drawings. In the following description, the common component in embodiments will be denoted by the same reference numeral and be omitted in further description.

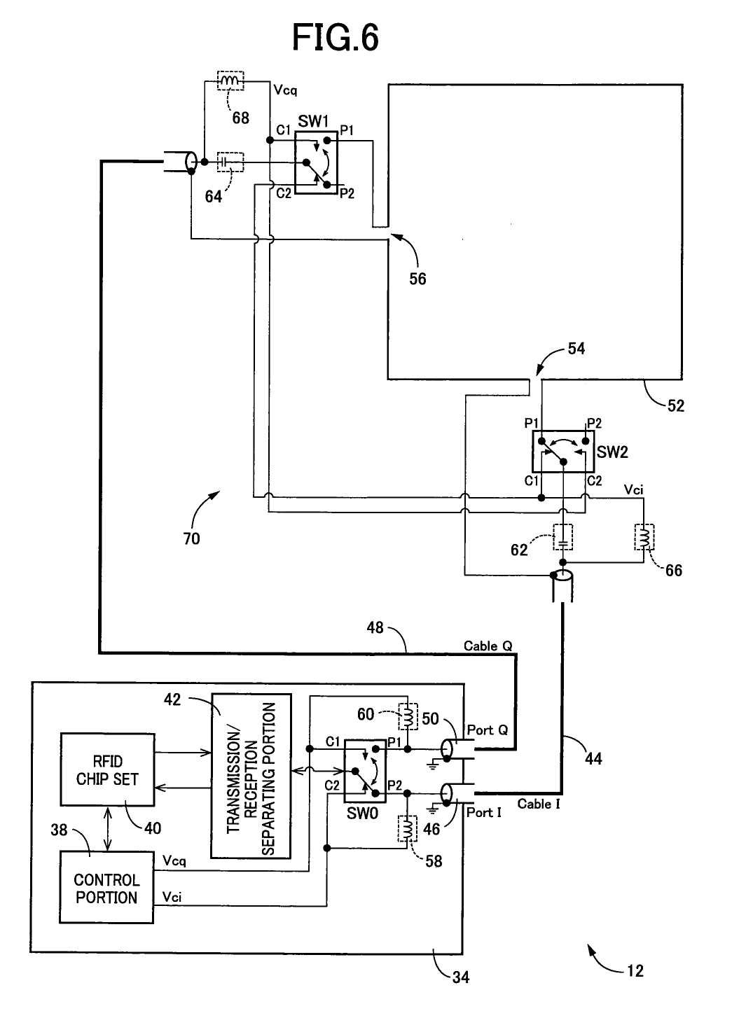

As depicted in FIG. 6, the first switch SW1 incorporated in a loop antenna unit 70 of this embodiment switches connection and disconnection between the inner conductor of the second feeding cable 48 and the second feeding point 56 of the antenna element 52. When connected to the terminal P1, the first switch SW1 connects the inner conductor of the second feeding cable 48 to the second feeding point 56 of the antenna element 52. When connected to the terminal P2, the first switch SW1 disconnects the inner conductor of the second feeding cable 48 from the second feeding point 56 of the antenna element 52. The outer conductor of the second feeding cable 48 is kept connected to the second feeding point 56. The second switch SW2 switches connection and disconnection between the inner conductor of the first feeding cable 44 and the first feeding point 54 of the antenna element 52. When connected to the terminal P1, the second switch SW2 connects the inner conductor of the first feeding cable 44 to the first feeding point 54 of the antenna element 52. When connected to the terminal P2, the second switch SW2 disconnects the inner conductor of the first feeding cable 44 from the first feeding point 54 of the antenna element 52. The outer conductor of the first feeding cable 44 is kept connected to the first feeding point 54.

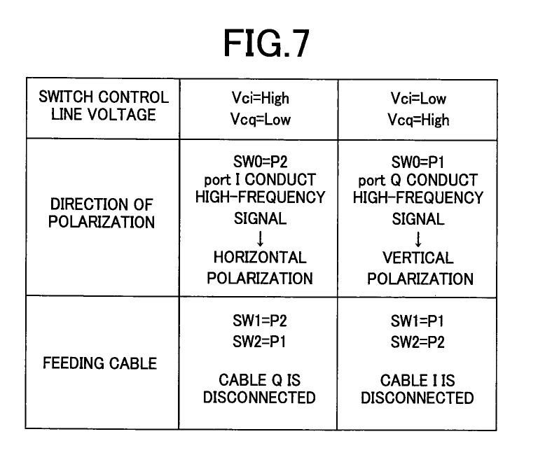

In the loop antenna unit 70 configured in the manner, the first and second switches SW1 and SW2 switch on and off in response to the dc signals Vci and Vcq supplied from the control portion 38 of the body 34 to the switches SW1 and SW2 via the feeding cables 44 and 48. As in the embodiment, the truth table representing control over switching by the first and second switches SW1 and SW2 is depicted in FIG. 4. FIG. 7 is an explanatory diagram of control over polarization plane switching responding to the dc signals Vci and Vcq in the loop antenna unit 70. As depicted in FIGS. 4 and 7, when the dc signal Vci corresponding to horizontal polarization out of the dc signals Vci and Vcq is higher in voltage than the dc signal Vcq corresponding to vertical polarization, the first switch SW1 is connected to the terminal P2 while the second switch SW2 is connected to the terminals P1. In this state, as described above, the 0th switch SW0 in the body 34 is connected to the terminal P2 to connect the transmission/reception separating portion 42 to the first port 46, which causes a high-frequency signal output from the transmission/reception separating portion 42 to be supplied to the first feeding cable 44. In this state, the inner conductor of the first feeding cable 44 is connected to the first feeding point 54 (outer conductor is kept connected), which is thus electrically connected to the transmission/reception separating portion 42. As a result, the antenna element 52 functions as a horizontal polarization antenna. Meanwhile, the inner conductor of the second feeding cable 48 corresponding to the unused second feeding point 56 is disconnected from the second feeding point 56.

As depicted in FIGS. 4 and 7, when the dc signal Vcq corresponding to vertical polarization out of the dc signals Vci and Vcq is higher in voltage than the dc signal Vci corresponding to horizontal polarization, the first switch SW1 is connected to the terminal P1 while the second switch SW2 is connected to the terminal P2. In this state, as described above, the 0th switch SW0 in the body 34 is connected to the terminal P1 to connect the transmission/reception separating portion 42 to the second port 50, which causes a high-frequency signal output from the transmission/reception separating portion 42 to be supplied to the second feeding cable 48. In this state, the inner conductor of the second feeding cable 48 is connected to the second feeding point 56 (outer conductor is kept connected), which is thus electrically connected to the transmission/reception separating portion 42. As a result, the antenna element 52 functions as a vertical polarization antenna. Meanwhile, the inner conductor of the first feeding cable 44 corresponding to the unused first feeding point 54 is disconnected from the first feeding point 54.

According to this embodiment, the first and second switches SW1 and SW2 serving as the circuit switching portion disconnect the inner conductor of a coaxial cable corresponding to an unused feeding point out of the first and second feeding points 54 and 56, from the unused feeding point in response to the dc signals Vci and Vcq. This achieves suitable polarization plane switching in a simpler configuration.

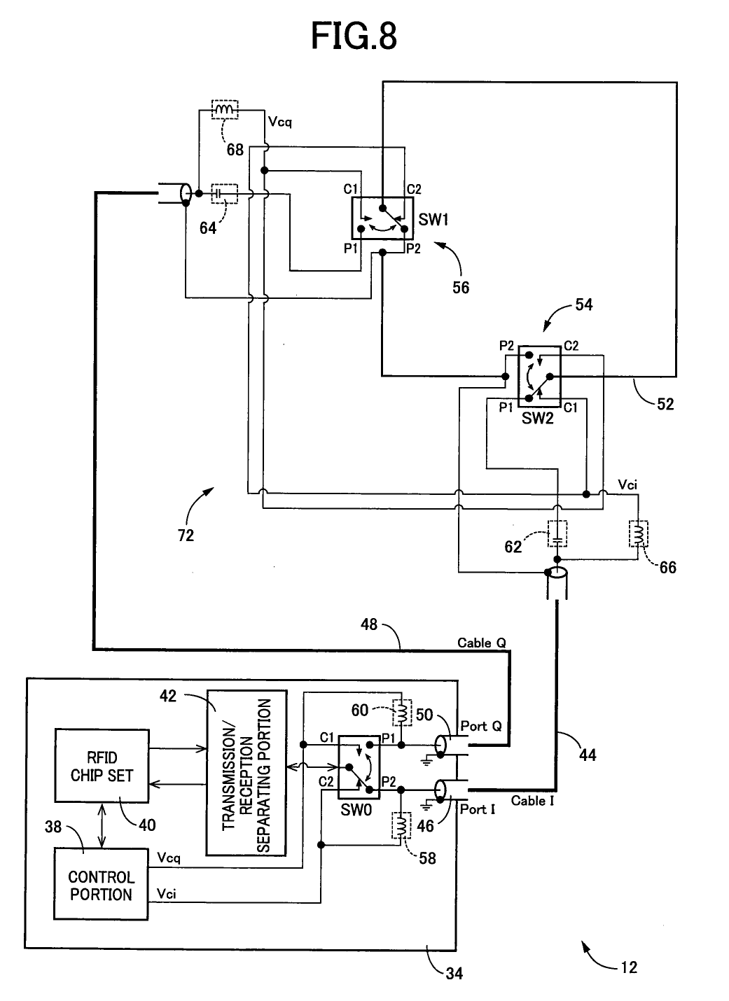

Although it is not mentioned in the embodiment, the antenna element 52 has the portion corresponding to the first feeding point 54 and the portion corresponding to the second feeding point 56 that are configured as electrically disconnected discontinuous portions, as depicted in FIG. 8. The first switch SW1 incorporated in a loop antenna unit 72 of this embodiment switches connection and disconnection between the inner conductor of the second feeding cable 48 and the second feeding point 56 of the antenna element 52, and when switching to a disconnecting position, brings the discontinuous portion of the antenna element corresponding to the second feeding point 56 into connection (coupling). When connected to the terminal P1, the first switch SW1 connects the inner conductor of the second feeding cable 48 to the second feeding point 56 of the antenna element 52. When connected to the terminal P2, the first switch SW1 disconnects the inner conductor of the second feeding cable 48 from the second feeding point 56 of the antenna element 52 while bringing the second feeding point 56 as the discontinuous portion into an electrically coupled state. The outer conductor of the second feeding cable 48 is kept connected to the second feeding point 56. The second switch SW2 switches connection and disconnection between the inner conductor of the first feeding cable 44 and the first feeding point 54 of the antenna element 52, and when switching to a disconnecting position, brings the discontinuous portion of the antenna element corresponding to the first feeding point 54 into connection (coupling). When connected to the terminal P1, the second switch SW2 connects the inner conductor of the first feeding cable 44 to the first feeding point 54 of the antenna element 52. When connected to the terminal P2, the first switch SW1 disconnects the inner conductor of the first feeding cable 44 from the first feeding point 54 of the antenna element 52 while bringing the first feeding point 54 as the discontinuous portion into an electrically coupled state. The outer conductor of the first feeding cable 44 is kept connected to the first feeding point 54.

In the loop antenna unit 72 configured in the manner, the first and second switches SW1 and SW2 switch on and off in response to the dc signals Vci and Vcq supplied from the control portion 38 of the body 34 to the switches SW1 and SW2 via the feeding cables 44 and 48. As in the embodiment, the truth table representing control over switching by the first and second switches SW1 and SW2 is depicted in FIG. 4. As in the embodiment, control over polarization plane switching responding to the dc signals Vci and Vcq in the loop antenna unit 72 is depicted in FIG. 7. As depicted in FIGS. 4 and 7, when the dc signal Vci corresponding to horizontal polarization out of the dc signals Vci and Vcq is higher in voltage than the dc signal Vcq corresponding to vertical polarization, the first switch SW1 is connected to the terminal P2 while the second switch SW2 is connected to the terminal P1. In this state, as described above, the 0th switch SW0 in the body 34 is connected to the terminal P2 to connect the transmission/reception separating portion 42 to the first port 46, which causes a high-frequency signal output from the transmission/reception separating portion 42 to be supplied to the first feeding cable 44. In this state, the inner conductor of the first feeding cable 44 is connected to the first feeding point 54 (outer conductor is kept connected), which is thus electrically connected to the transmission/reception separating portion 42. As a result, the antenna element 52 functions as a horizontal polarization antenna. Meanwhile, the inner conductor of the second feeding cable 48 corresponding to the unused second feeding point 56 is disconnected from the second feeding point 56 as the second feeding point 56 as the discontinuous portion is brought into electrical connection (coupling) by the first switch SW1.

As depicted in FIGS. 4 and 7, when the dc signal Vcq corresponding to vertical polarization out of the dc signals Vci and Vcq is higher in voltage than the dc signal Vci corresponding to horizontal polarization, the first switch SW1 is connected to the terminal P1 while the second switch SW2 is connected to the terminal P2. In this state, as described above, the 0th switch SW0 in the body 34 is connected to the terminal P1 to connect the transmission/reception separating portion 42 to the second port 50, which causes a high-frequency signal output from the transmission/reception separating portion 42 to be supplied to the second feeding cable 48. In this state, the inner conductor of the second feeding cable 48 is connected to the second feeding point 56 (outer conductor is kept connected), which is thus electrically connected to the transmission/reception separating portion 42. As a result, the antenna element 52 functions as a vertical polarization antenna. Meanwhile, the inner conductor of the first feeding cable 44 corresponding to the unused first feeding point 54 is disconnected from the first feeding point 54 as the first feeding point 54 as the discontinuous portion is brought into electrical connection (coupling) by the second switch SW2.

According to this embodiment, when the antenna element 52 has a discontinuous portion, the first and second switches SW1 and SW2 serving as the circuit switching portion disconnect the inner conductor of a coaxial cable corresponding to an unused feeding point out of the first and second feeding points 54 and 56, from the unused feeding point in response to the dc signals Vci and Vcq while bringing the discontinuous portion of the antenna element 52 corresponding to the unused feeding point into connection. This achieves suitable polarization plane switching in a simple configuration, and further improves communication by the antenna element 52.

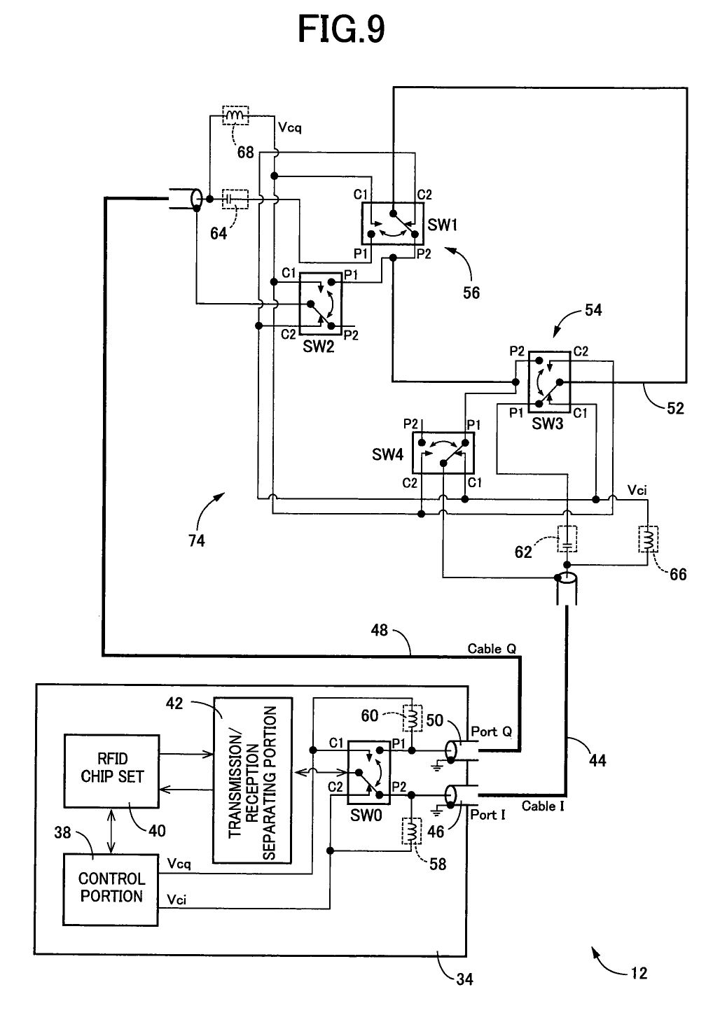

As depicted in FIG. 9, the antenna element 52 has the portion corresponding to the first feeding point 54 and the portion corresponding to the second feeding point 56 that are electrically disconnected discontinuous portions. The first switch SW1 of a loop antenna unit 74 of this embodiment switches connection and disconnection between the inner conductor of the second feeding cable 48 and the second feeding point 56 of the antenna element 52, and when switched to the disconnecting position, brings the discontinuous portion of the antenna element corresponding to the second feeding point 56 into connection (coupling). When connected to the terminal P1, the first switch SW1 connects the inner conductor of the second feeding cable 48 to the second feeding point 56 of the antenna element 52. When connected to the terminal P2, the first switch SW1 disconnects the inner conductor of the second feeding cable 48 from the second feeding point 56 of the antenna element 52 while bringing the second feeding point 56 as the discontinuous portion into an electrically coupled state. The second switch SW2 switches connection and disconnection between the outer conductor of the second feeding cable 48 and the second feeding point 56 of the antenna element 52. When connected to the terminal P1, the second switch SW2 connects the outer conductor of the second feeding cable 48 to the second feeding point 56 of the antenna element 52. When connected to the terminal P2, the second switch SW2 disconnects the outer conductor of the second feeding cable 48 from the second feeding point 56 of the antenna element 52. The third switch SW3 switches connection and disconnection between the inner conductor of the first feeding cable 44 and the first feeding point 54 of the antenna element 52, and when switched to the disconnecting position, brings the discontinuous portion of the antenna element corresponding to the first feeding point 54 into connection (coupling). When connected to the terminal P1, the third switch SW3 connects the inner conductor of the first feeding cable 44 to the first feeding point 54 of the antenna element 52. When connected to the terminal P2, the third switch SW3 disconnects the inner conductor of the first feeding cable 44 from the first feeding point 54 of the antenna element 52 while bringing the first feeding point 54 as the discontinuous portion into an electrically coupled state. The fourth switch SW4 switches connection and disconnection between the outer conductor of the first feeding cable 44 and the first feeding point 54 of the antenna element 52. When connected to the terminal P1, the fourth switch SW4 connects the outer conductor of the first feeding cable 44 to the first feeding point 54 of the antenna element 52. When connected to the terminal P2, the fourth switch SW4 disconnects the outer conductor of the first feeding cable 44 from the first feeding point 54 of the antenna element 52.

In the loop antenna unit 74 configured in the manner, the first to fourth switches SW1 to SW4 switch on and off in response to the dc signals Vci and Vcq supplied from the control portion 38 of the body 34 to the switches SW1 to SW4 via the feeding cables 44 and 48. As in the embodiment, the truth table representing control over switching by the first to fourth switches SW1 to SW4 is depicted in FIG. 4. As in the embodiment, control over polarization plane switching responding to the dc signals Vci and Vcq in the loop antenna unit 74 is depicted in FIG. 5. As depicted in FIGS. 4 and 5, when the dc signal Vci corresponding to horizontal polarization out of the dc signals Vci and Vcq is higher in voltage than the dc signal Vcq corresponding to vertical polarization, the first switch SW1 and the second switch SW2 are connected to the terminals P2 while the third switch SW3 and the fourth switch SW4 are connected to the terminals P1. In this state, as described above, the 0th switch SW0 in the body 34 is connected to the terminal P2 to connect the transmission/reception separating portion 42 to the first port 46, which causes a high-frequency signal output from the transmission/reception separating portion 42 to be supplied to the first feeding cable 44. In this state, both inner conductor and outer conductor of the first feeding cable 44 is connected to the first feeding point 54, which is thus electrically connected to the transmission/reception separating portion 42. As a result, the antenna element 52 functions as a horizontal polarization antenna. Meanwhile, both inner conductor and outer conductor of the second feeding cable 48 corresponding to the unused second feeding point 56 are disconnected from the second feeding point 56 as the second feeding point 56 as the discontinuous portion is brought into electrical connection (coupling) by the first switch SW1.

As depicted in FIGS. 4 and 5, when the dc signal Vcq corresponding to vertical polarization out of the dc signals Vci and Vcq is higher in voltage than the dc signal Vci corresponding to horizontal polarization, the first switch SW1 and the second switch SW2 are connected to the terminals P1 while the third switch SW3 and the fourth switch SW4 are connected to the terminals P2. In this state, as described above, the 0th switch SW0 in the body 34 is connected to the terminal P1 to connect the transmission/reception separating portion 42 to the second port 50, which causes a high-frequency signal output from the transmission/reception separating portion 42 to be supplied to the second feeding cable 48. In this state, both inner conductor and outer conductor of the second feeding cable 48 is connected to the second feeding point 56, which is thus electrically connected to the transmission/reception separating portion 42. As a result, the antenna element 52 functions as a vertical polarization antenna. Meanwhile, both inner conductor and outer conductor of the first feeding cable 44 corresponding to the unused first feeding point 54 are disconnected from the first feeding point 54 as the first feeding point 54 as the discontinuous portion is brought into electrical connection (coupling) by the third switch SW3.

According to this embodiment, when the antenna element 52 has a discontinuous portion, the first to fourth switches SW1 to SW4 serving as the circuit switching portion disconnect both inner conductor and outer conductor of a coaxial cable corresponding to an unused feeding point out of the first and second feeding points 54 and 56, from the unused feeding point in response to the dc signals Vci and Vcq while bringing the discontinuous portion of the antenna element 52 corresponding to the unused feeding point into connection. This achieves suitable polarization plane switching in a practical form, and further improves communication by the antenna element 52.

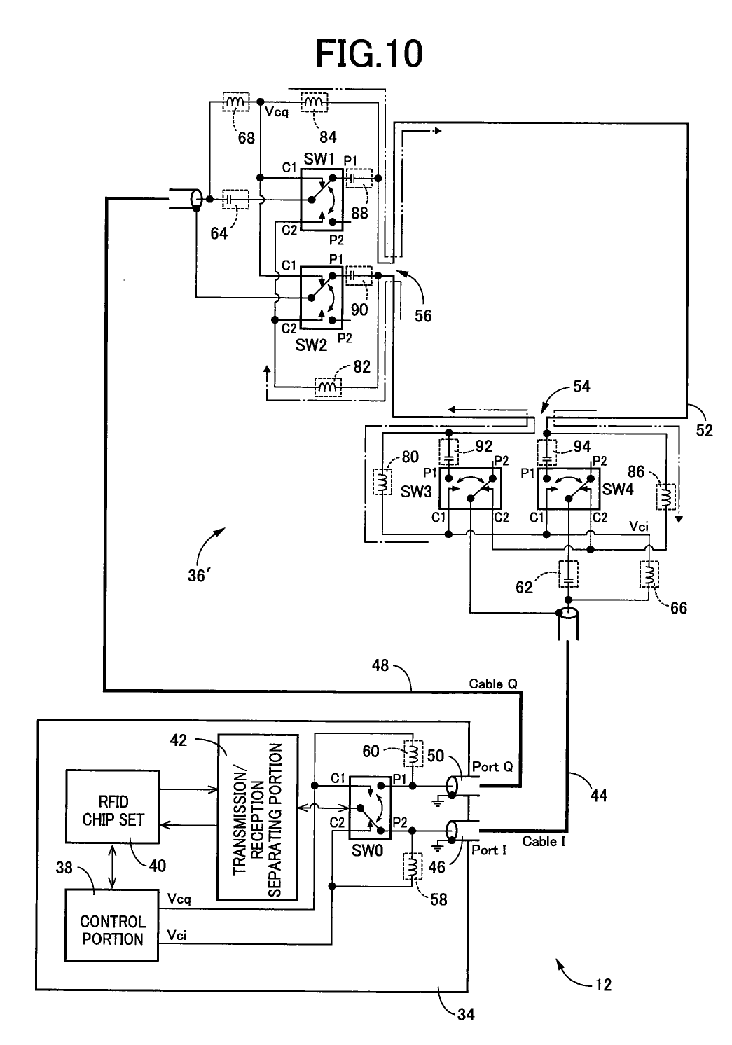

A loop antenna unit 36′ of FIG. 10 is a modification of the loop antenna unit 36 of FIG. 3, having a configuration in which a dc signal is superposed in the antenna element 52 to dispense with a control line between feeding points. The loop antenna unit 36′ of FIG. 10 includes an LPF 80 serving as a third filter that cuts off inflow of a high-frequency signal from a signal supplied through the first feeding cable 44 into control terminals of the third and fourth switches SW3 and SW4, an LPF 82 serving as a fourth filter that extracts the dc signal Vci from a signal supplied via the antenna element 52 to supply the extracted dc signal Vci to the first and second switches SW1 and SW2, an LPF 84 serving as a third filter that cuts off inflow of a high-frequency signal from a signal supplied through the second feeding cable 48 into control terminals of the first and second switches SW1 and SW2, and an LPF 86 serving as a fourth filter that extracts the dc signal Vcq from a signal supplied via the antenna element 52 to supply the extracted dc signal Vcq to the third and fourth switches SW3 and SW4. The loop antenna unit 36′ also includes HPFs 88, 90, 92, and 94 serving as fifth filters that are provided in one-to-one correspondence to the first to fourth switches SW1 to SW4 to cut off inflow of the dc signals Vci and Vcq supplied to the antenna element 52 into the feeding cables 44 and 48. The HPFs 88, 90, 92, and 94 may be provided by using coupling capacitors necessary for switch device operation also as the HPFs, in which case separate HFPs are unnecessary.

In the loop antenna unit 36′ configured in the manner, as indicated by a chain line arrow, the LPF 80 extracts the dc signal Vci from a signal supplied through the first feeding cable 44 to supply the extracted dc signal Vci to the antenna element 52, in which the dc signal Vci is superposed and transmitted. The signal Vci supplied from the antenna element 52 then travels through the LPF 82 to the first and second switches SW1 and SW2, where switching by the first and second switches SW1 and SW2 is controlled based on the dc signal Vci. As indicated by a two-dot chain line arrow, the LPF 84 extracts the dc signal Vcq from a signal supplied through the second feeding cable 48 to supply the extracted dc signal Vcq to the antenna element 52, in which the dc signal Vcq is superposed and transmitted. The signal Vcq supplied from the antenna 52 then travels through the LPF 86 to the third and fourth switches SW3 and SW4, where switching by the third and fourth switches SW3 and SW4 is controlled based on the dc signal Vcq. The HPFs 88, 90, 92, and 94 cut off (inhibit) inflow of the dc signals Vci and Vcq supplied to the antenna element 52 into the feeding cables 44 and 48.

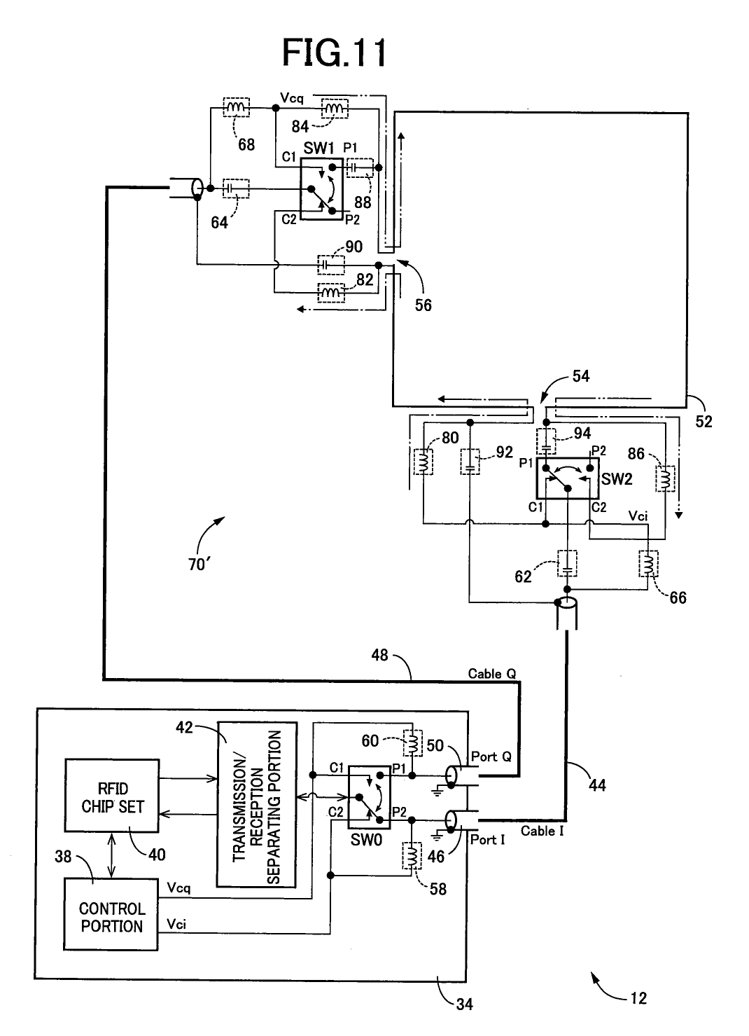

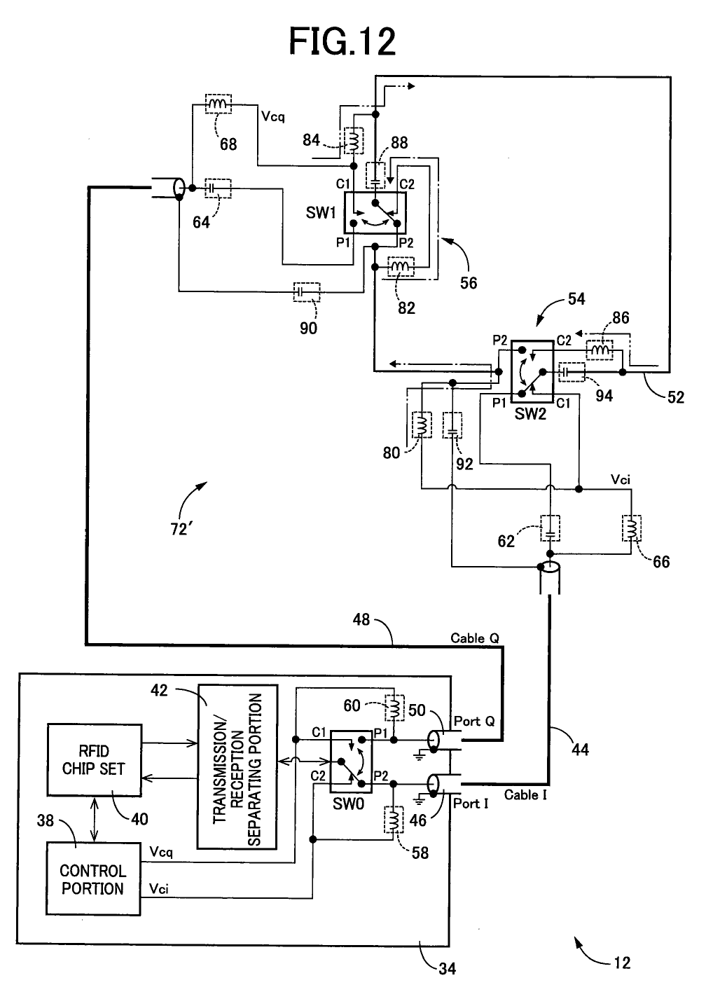

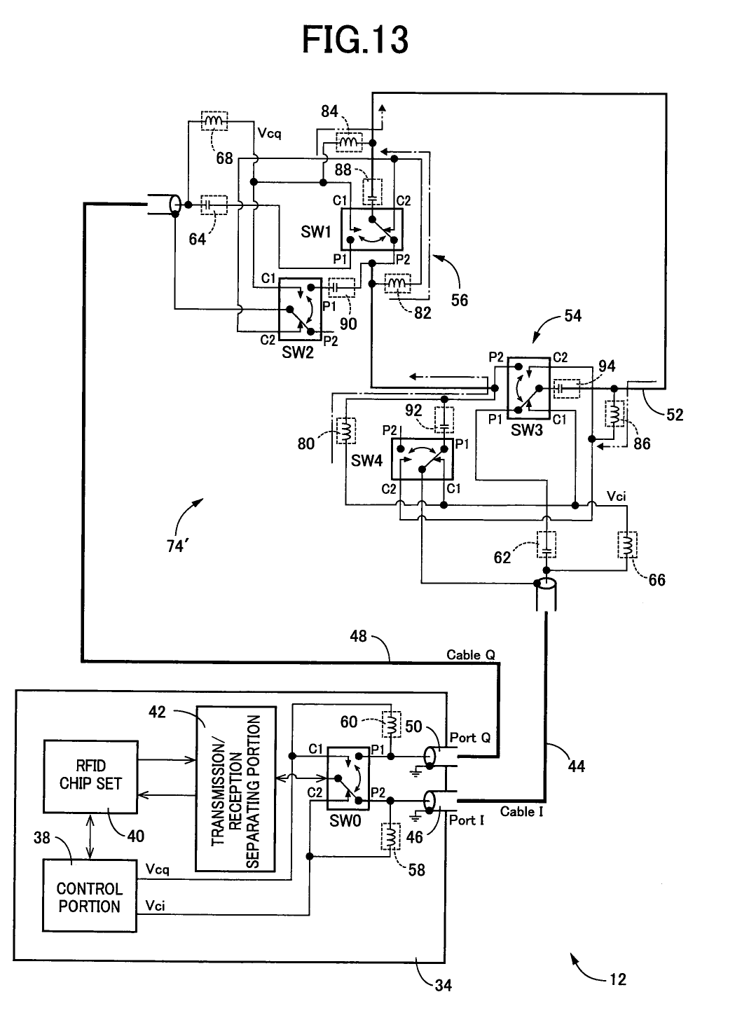

A loop antenna unit 70′ of FIG. 11 is a modification of the loop antenna unit 70 of FIG. 6, having a configuration in which a dc signal is superposed in the antenna element 52 to dispense with a control line between feeding points, as in the embodiment. A loop antenna unit 72′ of FIG. 12 is a modification of the loop antenna unit 72 of FIG. 8, having a configuration in which a dc signal is superposed in the antenna element 52 to dispense with a control line between feeding points, as in the embodiment. A loop antenna unit 74′ of FIG. 13 is a modification of the loop antenna unit 74 of FIG. 9, having a configuration in which a dc signal is superposed in the antenna element 52 to dispense with a control line between feeding points, as in the embodiment.

In this manner, each of the loop antenna units 36′, 70′, 72′, and 74′ of this embodiment includes the LPFs 80 and 84 serving as the third filters that cut off inflow of high-frequency signals from signals supplied through the first and second feeding cables 44 and 48 into the first to fourth switches SW1 to SW4, the LPFs 82 and 86 serving as the fourth filters that extract the dc signals Vci and Vcq for control over switching by the first to fourth switches SW1 to SW4 from signals supplied via the antenna element 52 to supply the extracted dc signals Vci and Vcq to the first to fourth switches SW1 to SW4, and the HPFs 88, 90, 92, and 94 serving as the fifth filters that cut off inflow of the dc signals Vci and Vcq supplied to the antenna element 52 into the feeding cables 44 and 48. According to the loop antenna units 36′, 70′, 72′, and 74′, in a configuration having two or more circuit switching portions, a control line is not needed to be provided between the circuit switching portions, so that the configuration of the loop antenna unit can be simplified substantially.

While preferred embodiments of the present invention have been described in detail with reference to the drawings, the present invention is not limited by this description but may be carried out in another mode.

For example, a case of providing the loop antenna unit 36, etc., of the present invention as a transmitting antenna and a receiving antenna in the radio tag communication apparatus 12 that communicates with the radio tag 14 for information exchange is described in the embodiments. The present invention is not limited to this case. For example, the present invention may be applied only to the transmitting antenna or to the receiving antenna of the radio tag communication apparatus 12. The loop antenna unit of the present invention is preferably applied also to a communication apparatus other than the RFID system.

The HPFs 88, 92, and 94 may be provided by using coupling capacitors necessary for switch device operation also as the HPFs, in which case separate HFPs are unnecessary.

While the loop antenna unit 36, etc., has the antenna element 52 of a rectangular shape in the embodiments, the loop antenna unit 36, etc., may have the antenna element 52 of, for example, a circular or elliptical shape. The form of the loop antenna, therefore, is properly selected from various forms in accordance with the design of the loop antenna.

Although no specific examples are presented, the present invention may variously be modified or altered without departing from the spirit of the invention.

What is claimed is:

1. A loop antenna unit comprising:
a looped antenna element;
a first feeding cable that feeds power to a first feeding point on the antenna element;
a second feeding cable that feeds power to a second feeding point on the antenna element; and
a circuit switching portion that disconnects a feeding cable corresponding to an unused feeding point out of the first feeding point and the second feeding point, from the unused feeding point, wherein
the feeding cable transmits a signal generated by superposing a high-frequency signal related to communication by the loop antenna unit on a dc signal for control over switching by the circuit switching portion, and wherein
the loop antenna unit further comprises:
a first filter that extracts a high-frequency signal related to communication by the loop antenna unit from a signal supplied through the feeding cable and supplies the extracted high-frequency signal to the antenna element; and
a second filter that extracts a dc signal for control over switching by the circuit switching portion from a signal supplied through the feeding cable and supplies the extracted dc signal to the circuit switching portion, the first filter and the second filter being provided for the first feeding cable and for the second feeding cable, respectively.

2. The loop antenna unit of claim 1, wherein
the loop antenna unit is incorporated in a communication apparatus that carries out control over polarization plane switching of switching a polarization plane of the loop antenna unit, and wherein
a dc signal for control over switching by the circuit switching portion is used also as a switching signal for switching connection for the high-frequency signal in control over polarization plane switching by the communication apparatus.

3. The loop antenna unit of claim 1, wherein
each of the first feeding cable and the second feeding cable is a coaxial cable having an inner conductor and an outer conductor that are arranged coaxially.

4. The loop antenna unit of claim 3, wherein
the circuit switching portion disconnects both inner conductor and outer conductor of a coaxial cable corresponding to an unused feeding point out of the first feeding point and the second feeding point, from the unused feeding point in response to the dc signal.

5. The loop antenna unit of claim 3, wherein
the circuit switching portion disconnects an inner conductor of a coaxial cable corresponding to an unused feeding point out of the first feeding point and the second feeding point, from the unused feeding point in response to the dc signal.

6. The loop antenna unit of claim 3, wherein
when the antenna element has a discontinuous portion, the circuit switching portion disconnects an inner conductor of the coaxial cable corresponding to an unused feeding point out of the first feeding point and the second feeding point, from the unused feeding point in response to the dc signal while bringing the discontinuous portion of the antenna element corresponding to the unused feeding point into connection.

7. The loop antenna unit of claim 3, wherein
when the antenna element has a discontinuous portion, the circuit switching portion disconnects both inner conductor and outer conductor of the coaxial cable corresponding to an unused feeding point out of the first feeding point and the second feeding point, from the unused feeding point in response to the dc signal while bringing the discontinuous portion of the antenna element corresponding to the unused feeding point into connection.

8. The loop antenna unit of claim 1, comprising:
a third filter that supplies a dc signal for control over switching by the circuit switching portion to the antenna element while cutting off inflow of a high-frequency signal related to communication by the antenna element into the circuit switching portion;
a fourth filter that extracts a dc signal for control over switching by the circuit switching portion from a signal supplied via the antenna element and supplies the extracted dc signal to the circuit switching portion; and
a fifth filter that cuts off inflow of the dc signal supplied to the antenna element into the feeding cable.
